(19) United States
(12) Patent Application Publication
(10) Pub. No.: US 2013/0127612 A1
(43) Pub. Date: May 23, 2013

(54) TURN SIGNAL LIGHTING SYSTEM FOR A MOTOR VEHICLE, AND METHOD OF OPERATING A TURN SIGNAL LIGHTING SYSTEM

(71) Applicant: AUDI AG, Ingolstadt (DE)

(72) Inventors: Manfred Stadler, Neuburg (DE); Torsten Schwarz, Gaimersheim (DE); Reiner Lendle, Hassmersheim (DE); Benjamin Hummel, Mockmuhl (DE)

(73) Assignee: AUDI AG, Ingolstadt (DE)

(21) Appl. No.: 13/683,682

(22) Filed: Nov. 21, 2012

(30) Foreign Application Priority Data
Nov. 23, 2011 (DE) 10 2011 119 230.5

(51) Int. Cl. B60Q 1/34

(52) U.S. Cl. CPC B60Q 1/34
USPC 340/465

(57) ABSTRACT

In a method of operating a turn signal lighting system, in a flashing cycle a first group of a plurality of LED groups arranged in a row is initially activated, with each of the LED groups including at least one light emitting diode. Thereafter, the other groups of the plurality of LED groups are successively activated until the plurality of LED groups are all in an ON state. The plurality of LED groups is then maintained in the ON state for a predetermined time period before being deactivated. The overall time period from activating the first group of the plurality of LED groups up until reaching the ON state of the plurality of LED groups ranges hereby from 100 ms to 200 ms.

### CROSS-REFERENCES TO RELATED APPLICATIONS

This application claims the priority of German Patent Application, Serial No. 10 2011 119 230.5, filed Nov. 23, 2011, pursuant to 35 U.S.C. 119(a)-(d), the content of which is incorporated herein by reference in its entirety as if fully set forth herein.

### BACKGROUND OF THE INVENTION

The present invention relates to a turn signal lighting system for a motor vehicle, and method of operating a turn signal lighting system.

The following discussion of related art is provided to assist the reader in understanding the advantages of the invention, and is not to be construed as an admission that this related art is prior art to this invention.

Turn signal lighting systems, or short signal lamps, are used in motor vehicles to indicate a travel direction and are alternatingly turned on or off within a flashing cycle, i.e. each flashing cycle includes an active period during which the signal lamp illuminates and an inactive period during which the signal lamp remains dark. The flash frequency ranges hereby between 1 Hz and 2 Hz. Signal lamps approved for road traffic have to comply with certain regulations. For example, all signal lamps of a motor vehicle to indicate a change in travel direction should be visible in a same phase, i.e. the active periods of the various signal lamps should overlap in time. It is, however, impossible for technical reasons to have all signal lamps illuminate at precisely the same time. For example, an incandescent bulb, when used as illumination, requires between 150 ms and 200 ms to reach its full light intensity after being switched on. Likewise, an incandescent bulb requires about 100 ms to darken completely after being switched off.

The use of a moving pattern of light has been proposed to signal to an observer an imminent change in travel direction. In many countries, such a moving pattern of light is however not approved for indication of a change in travel direction. For example, ECE regulations (ECE—Economic Commission for Europe) set standards that require a signal lamp to remain stationary in relation to the vehicle when flashing during indication of a travel direction. This means that a moving pattern of light in the illuminated area from one side to another during flashing is not permitted.

It would be desirable and advantageous to provide an improved turn signal lighting system to obviate prior art shortcomings and yet to comply with legal standards.

### SUMMARY OF THE INVENTION

According to one aspect of the present invention, a method of operating a turn signal lighting system includes in a flashing cycle the steps of activating a first group of a plurality of LED groups arranged in a row, with each of the LED groups including at least one light emitting diode, activating the other groups of the plurality of LED groups successively until the plurality of LED groups are all in an ON state, maintaining the plurality of LED groups in the ON state for a predetermined time period, and deactivating the plurality of LED groups, wherein an overall time period from activating the first group of the plurality of LED groups up until reaching the ON state of the plurality of LED groups ranges from 100 ms to 200 ms.

In accordance with the present invention, when indicating a change in travel direction, a turn signal lighting system is operated in such a way that, starting from a situation when all LED groups are in OFF state, within each flashing cycle initially a first group of the plurality of LED groups is switched on. For example, when the lighting system has thirty five light emitting diodes in a row, it is conceivable to initially switch on ten or twelve adjacent light emitting diodes as first group. Thereafter, the remaining LED groups are activated successively until all LED groups are in ON state. The remaining LED groups may, for example, each include three adjacent light emitting diodes in the row. All LED groups are then maintained in the ON state for a predetermined time period before being deactivated or switched off. The overall time period from switching on the first group of the plurality of LED groups up until reaching the ON state of the plurality of LED groups ranges from 100 ms to 200 ms. Currently preferred is an overall time period in the range from 140 ms to 160 ms.

A method according to the present invention has the advantage of providing for a motor vehicle a stationary, flashing illumination zone that is in compliance with legal requirements while still conveying the impression to an observer of an illumination zone that progressively broadens in at least one direction when the row of LED groups is successively switched on. This animation effect produced by the successive activation of the LED groups lasts between 100 ms and 200 ms. This time period is thus not longer than the duration for an incandescent bulb to reach its full brightness after being switched on. In other words, the turn signal lighting system according to the present invention operates within legal requirements. The invention is based on the recognition that a human observer perceives a flowing motion when sequentially activating a row of LED groups, with two successive LED groups being switched on at a time-staggered sequence which is less than 60 ms, advantageously less than 45 ms. This effect is also used in motion pictures where a switch between individual frames of a film occurs within 40 ms. While complying with the legally established time frame of 100 ms to 200 ms, the presence of several LED groups thus gives the impression of a continuously broadening illumination zone.

The attained animation effect has the added benefit that it becomes much easier for an observer to identify the turn signal lighting system in traffic even when the traffic situation is dense, and to recognize the indicated change in travel direction. As there is no sudden change from the passive phase to the active phase but rather a transition is created of up to 200 ms, the signal lamp becomes more apparent to a human observer. As a result, the time that a human needs to recognize the active signal lamp is reduced. Another advantage of a turn signal lighting system according to the invention is the attractive look that can promote increased demand for such a signal lamp.

According to another advantageous feature of the present invention, the predetermined time period during which all LED groups jointly are in ON state may range from 50 ms to 400 ms. Currently preferred is a range from 200 ms to 300 ms. Together with the duration of the animation effect, an active phase of the turn signal lighting system can be produced that lasts long enough for an observer to clearly and easily recognize an indicated change in travel direction.

According to another advantageous feature of the present invention, the first group of the plurality of LED groups can be located at an end of the row. The row of LED groups can thus be dimmed up from one end to the other end in the form of a wipe effect that lasts 100 ms to 200 ms. It has been shown that this updimming in terms of time and location of the turn signal lighting system gives an observer the impression of a moving light without the need for more time than would be required when switching on an incandescent bulb.

According to another advantageous feature of the present invention, the first group of the plurality of LED groups may include at least eight light emitting diodes and have a width of 4 cm in a direction longitudinally along an extension of the row. A first group with such a configuration and such a dimension can produce a luminosity of such magnitude and an illuminated area of such width that a clearly visible indication of a travel direction is provided as soon as the first group is switched on.

According to another advantageous feature of the present invention, at least two light emitting diodes, advantageously less than six light emitting diodes, of each of the other groups of the plurality of LED groups can be activated simultaneously. Currently preferred is a simultaneous activation of three light emitting diodes per LED group. The presence of these LED groups having two to six light emitting diodes enables a significant simplification of a turn signal lighting signal according to the present invention in terms of circuitry. At the same time, a human observer does not perceive an incremental increase of the illuminated area from a distance of 2 m and more, when the various LED groups are activated in a time-staggered manner. Rather, the observer perceives a continuous increase in length of the illuminated area, when using six or less light emitting diodes per LED group.

According to another advantageous feature of the present invention, the other groups of the plurality of LED groups can be supplied for a predetermined time period with continuously increasing electric power as the other groups of the plurality of LED groups are sequentially activated. In this way, the impression of an updimming for a human observer is further reinforced without violating legal requirements. This feature of the novel and inventive method is also applicable for other lighting systems with light emitting diodes. Thus, the method according to the present invention should not be viewed as limited to turn signal lighting systems but also allows operation of other types of signal lamps or operation of brake light or headlights.

According to another aspect of the present invention, a turn signal lighting system for a motor vehicle includes a plurality of light emitting diodes arranged in a row and interconnected to form a plurality of LED groups, with each of the plurality of LED groups having at least one of the light emitting diodes, and a control device configured to activate a first group of the plurality of LED groups, to activate subsequently the other groups of the plurality of LED groups successively until the plurality of LED groups are all in an ON state, to maintain the plurality of LED groups in the ON state for a predetermined time period, and to deactivate the plurality of LED groups, wherein an overall time period from switching on the first group of the plurality of LED groups until reaching the ON state of the plurality of LED groups ranges from 100 ms to 200 ms.

According to another advantageous feature of the present invention, the light emitting diodes of at least one group of the plurality of LED groups can be arranged side-by-side in a direction longitudinally along an extension of the row. When a LED group is then activated, the illuminated area expands in the direction longitudinally along an extension of the row by a section which is predefined by the number of light emitting diodes combined in the LED group. Thus, when the LED groups are switched on, the rate by which the illuminated area broadens can be controlled.

According to another advantageous feature of the present invention, at least two groups of the plurality of LED groups can have different lengths in a direction longitudinally along an extension of the row. This gives the impression that the illuminated area widens during updimming at a rate which changes in time.

According to another advantageous feature of the present invention, at least one group of the plurality of LED groups can have at least two light emitting diodes. As a result, the interconnection of the circuitry becomes especially simple when producing a turn signal lighting device according to the invention. Advantageously, each of the groups of the plurality of LED groups can have three light emitting diodes.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of one embodiment of a turn signal lighting system according to the present invention;

FIG. 2 is a sequence diagram of flashing cycles as realized by a method according to the present invention for the turn signal lighting system of FIG. 1;

FIG. 3 is a different sequence diagram of flashing cycles as realized by a method according to the present invention for another embodiment of a turn signal lighting system according to the present invention; and

FIG. 4 are graphical illustrations of brightness patterns as a function of time.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

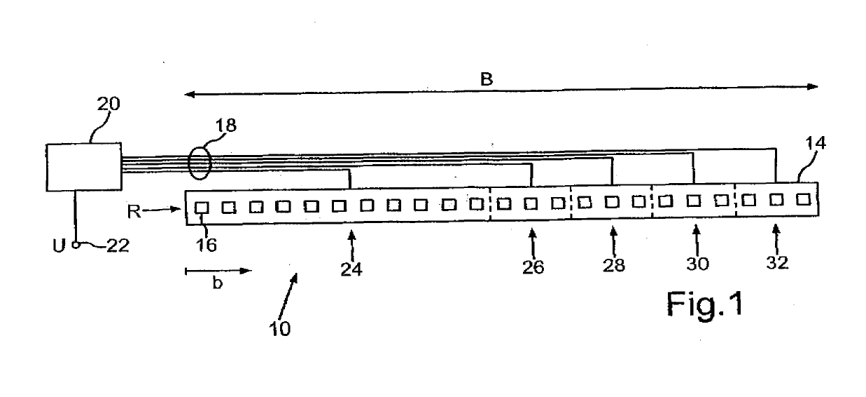

Turning now to the drawing, and in particular to FIG. 1, there is shown a schematic illustration of one embodiment of a turn signal lighting system according to the present invention, generally designated by reference numeral 10. FIG. 1 shows the inside of the turn signal lighting system 10 which is installed in a taillight of a passenger car. The turn signal lighting system 10 accommodates a circuit board (printed circuit board—PCB) 12 having a total of twenty-three light emitting diodes 16 soldered thereon. For sake of simplicity, only one of the light emitting diodes is labeled with reference numeral 16. The light emitting diodes 16 are lined up on the printed board 14 along a straight row. The printed board 14 is arranged in the turn signal lighting system 10 behind a transparent glass that has been dyed orange so that any light radiating out from the light emitting diodes 16 is perceived from outside by an observer as orange light. It is, of course, conceivable to replace a single printed board 14 with several printed boards on which the light emitting diodes are arranged.

The printed board 14 is connected to a control unit 20 by lines 18. The control unit 20 has an input 22 to receive a voltage signal which represents a control signal U for the turn signal lighting system 10. The control signal U is generated by an unillustrated controller of the motor vehicle. The control unit 20 may, for example, involve a microcontroller or a signal processor. Instead of using a control unit 20, it is also conceivable to connect the lines 18 directly to the controller.

The printed board 14 has (not shown) conductors for connecting the light emitting diodes 16 for operation with a (not shown) voltage source. Current flowing from the voltage source to the light emitting diodes 16 can be cut by switches which can be switched respectively via one of the lines 18 by the control unit 20. The conductors of the printed board 14 are arranged such that several light emitting diodes 16 are interconnected to form respective LED groups 24, 26, 28, 30, 32. As shown by way of example in FIG. 1, LED group 24 has eleven light emitting diodes 16 whereas LED groups 26, 28, 30, 32 have each three light emitting diodes 16.

The light emitting diodes 16 can be arranged at a same distance from one another on the printed board 14. An overall width B of the row of the LED groups 24, 26, 28, 30, 32 may amount to 50 cm. The width may, of course, vary for different embodiments of light emitting diodes and may amount between 40 and 60 cm.

The light emitting diodes 16 within a LED group 24, 26, 28, 30, 32 are interconnected by conductors of the printed board 14 such that a switching of a switch assigned to one of the LED groups 24, 26, 28, 30, 32 simultaneously activates the light emitting diodes 16 of this LED group via one of the lines 18.

In the non-limiting example of FIG. 1, a person in the motor vehicle actuates turn signal indicator. As a result, the controller then generates a square-wave voltage as control signal U at the input 22 of the control unit 20. A period of the square-wave voltage corresponds to the flash frequency with which the turn signal lighting system 10 is intended to flash for indication of the travel direction.

The light emitting diodes 16 are not simultaneously activated on the ascending flanks of the individual square-wave pulses of the control signal U by the control unit 20 via the lines 18. Instead, the LED group 24 is initially activated as the first group and only thereafter are the other LED groups 26, 28, 30 and finally the LED group 32 successively switched on in the row R. All LED groups 24, 26, 28, 30, 32, i.e. all light emitting diodes 16, are then switched off with a descending flank of the square-wave pulse of the control signal U. This flashing cycle repeats with the next ascending flank of the square-wave signal.

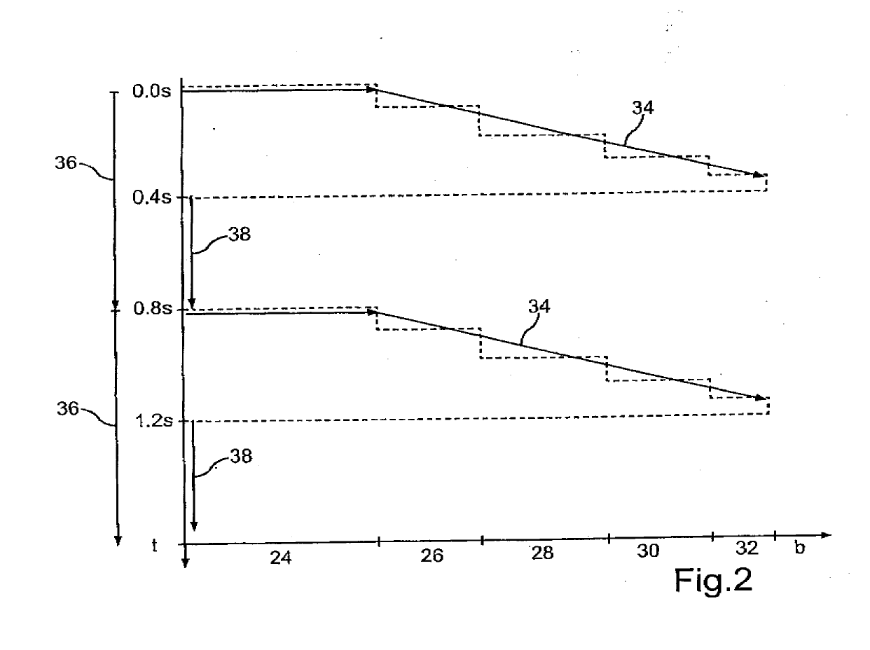

FIG. 2 shows a sequence diagram of two successive flashing cycles as realized by a method according to the present invention for the turn signal lighting system 10 of FIG. 1. A horizontal axis of the diagram of FIG. 2 depicts hereby which section b of the printed board 14 is perceived by an observer of the turn signal lighting system 10 as illuminated through the orange glass at a certain time instance t, i.e. the width of the illuminated area.

The transition from activating the LED group 24 as first group up to the activation of all the light emitting diodes 16 after the other LED groups 26, 28, 30, 32 have been added lasts 150 ms. Typically, this time period can amount between 100 and 200 ms. This updimming phase 34 of the turn signal lighting system 10 is thus short enough to give the observer of the turn signal lighting system 10 the impression that the turn signal lighting system 10 continuously brightens in a similar way as a signal lamp operated with incandescent bulbs. The turn signal lighting system 10 gives the observer however the added impression that the section b of the simultaneously illuminated light emitting diodes 16 evenly expands in a flowing motion. In the non-limiting example of FIG. 1, the observer perceives the turn signal lighting system 10 like a running light that expands to the right and back to thereby further emphasize the signaled direction.

Overall, the active phase or illumination phase of the turn signal lighting system 10 lasts 0.4 within a flashing cycle 36. This is followed by an inactive phase or OFF phase 38 which last also 0.4 seconds in this example.

As the light emitting diodes 16 of the turn signal lighting system 10 are arranged equidistant and each of the LED groups 26, 28, 30, 32 has three light emitting diodes 16, the observer has in the updimming phase 34 the impression of a constant speed with which the row of already illuminating light emitting diodes 16 expands, i.e. with which the illuminated section b expands, when the time interval between activation of two neighboring LED groups 26, 28, 30, 32 is the same.

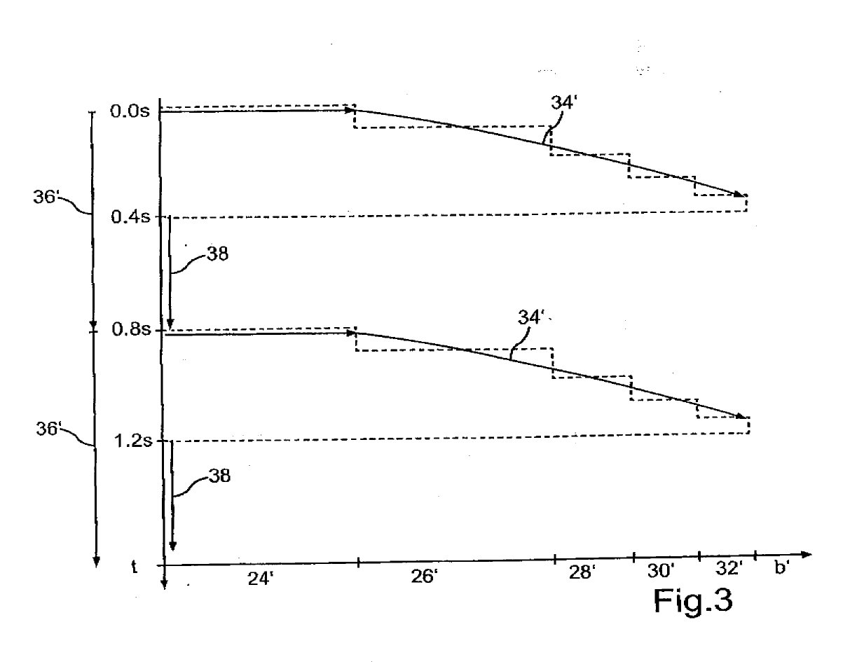

By combining different numbers of light emitting diodes in the LED groups 26, 28, 30, 32 or by varying the distances of the light emitting diodes in relation to one another, the width of the illuminated section b within a flashing cycle can increase as the speed varies. This is shown in FIG. 3 by way of a sequence diagram which resembles the one of FIG. 2. The sequence diagram of FIG. 3 shows for flashing cycles 36′ an updimming phase 34′ in which a width of an illuminated section b′ increases with a speed which decreases as the number of activated light emitting diodes rises. The speed, with which the width of an illuminated section b′ increases during the updimming phase 34′, varies as a function of the time t as a result of the presence of the LED groups 24′, 26′, 28′, 30′, 32′ of light emitting diodes having different numbers of light emitting diodes. The LED group 24′, activated at the commencement of each flashing cycle 36′, represents an initial or first group and may include 8 to 12 light emitting diodes. The neighboring LED group 26″ may include between 6 and 10 light emitting diodes. LED group 28′ has fewer light emitting diodes than LED group 26′, and LED group 30′ has, in turn, fewer light emitting diodes than LED group 28′. LED group 32′ has the least number of light emitting diodes. As the updimming phase 34′ lasts again less than 200 ms, the observer perceives also in this configuration the updimming of the turn signal lighting system 10 as a continuous event.

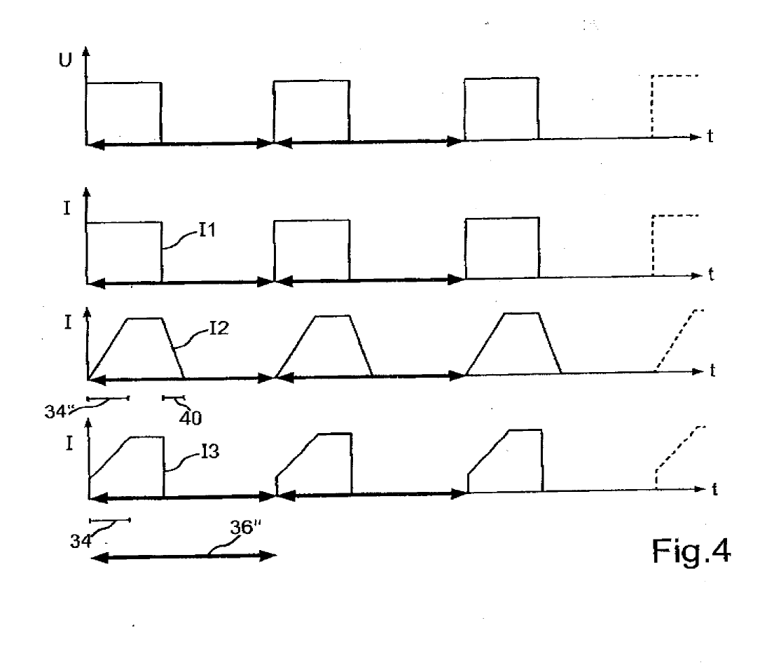

FIG. 4 shows a graphical illustration of brightness patterns as a function of time for various turn signal lighting systems. The value for the light intensities I is hereby established as the sum of the emitted lighting output at a certain time instance t. The lighting output is determined across the entire light exit area of the respective turn signal lighting system.

With respect to the individual patterns of the light intensity I, the uppermost graph of FIG. 4 depicts the course of the control signal U with which the turn signal lighting systems are activated. The pattern may, for example, also be generated by the controller of a motor vehicle at the input 22 of the control unit 20. The control signal U is a square-wave pulse signal with a period that may amount from 0.5 to 1 second. This results in the respective flashing cycles 36″.

With respect to the control signal U, an intensity pattern I1 is shown as established by a conventional signal lamp having light emitting diodes as lighting system. The light emitting diodes are hereby switched in correspondence with the control signal U. Intensity pattern I2 reflects the situation with a signal lamp having incandescent bulbs as lighting system. As described above, incandescent bulbs require up to 200 ms to reach their full brightness after being switched on. Intensity pattern I3 depicts the situation for the turn signal lighting system 10, using light emitting diodes 16 combined in LED groups 24, 26, 28, 30, 32 that are activated successively.

Intensity pattern I1 follows directly the control signal U. The light emitting diodes reach their maximum brightness within less than 1 ms after a respective ascending flank of the control signal U within a flashing cycle 36″. Intensity pattern I2 has a ramp-shaped ascension after each ascending flank of the control signal U. This updimming phase 34″ of the incandescent bulbs cannot be influenced and lasts between 100 and 200 ms. After a descending flank of the control signal U, the intensity pattern I2 decreases from its maximum value within the dimming down phase of about 100 ms and assumes a descending course.

The intensity pattern I3 depicts that the time period of the updimming phase 34 corresponds to the one of an incandescent bulb, i.e. the time period of the updimming phase 34″. The value of maximum light intensity is maintained in the intensity pattern I3 as long as in the intensity pattern I2. As a result, there is no difference in the turn signal lighting system 10 as far as duration and clarity of the signal for indication of the travel direction is concerned, when compared to a signal lamp with an incandescent bulb. In addition, however, the controlled expansion of the section b of the illuminating light emitting diodes 16 in the updimming phase 34 conveys to the observer a direction information. The impending change in travel direction is thus perceived by the observer intuitively.

The examples thus show the manner with which the lighting elements of a turn signal can be activated in a time-staggered manner. Activation of at least one lighting element can be followed by activation of further lighting elements in a chronological tight sequence so that the observer perceives a filling of a lighting body. As an alternative, at least a first lighting element can be operated with a higher energy than the other lighting elements, and the other lighting elements can be supplied successively with continuously increasing energy. This also gives the impression of a filling light. The mode of operation shown here with reference to a turn signal is equally applicable for a brake light or a headlight.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of operating a turn signal lighting system, comprising in a flashing cycle the steps of:
activating initially a first group of a plurality of LED groups arranged in a row, with each of the LED groups including at least one light emitting diode;
activating subsequently the other groups of the plurality of LED groups successively until the plurality of LED groups are all in an ON state;
maintaining the plurality of LED groups in the ON state for a predetermined time period; and
deactivating the plurality of LED groups,
wherein an overall time period from activating the first group of the plurality of LED groups up until reaching the ON state of the plurality of LED groups ranges from 100 ms to 200 ms.

2. The method of claim 1, wherein the overall time period ranges from 140 ms to 180 ms.

3. The method of claim 1, wherein the predetermined time period ranges from 50 ms to 400 ms.

4. The method of claim 1, wherein the predetermined time period ranges from 200 ms to 300 ms.

5. The method of claim 1, wherein the first group of the plurality of LED groups is located at an end of the row.

6. The method of claim 1, wherein the first group of the plurality of LED groups includes at least eight light emitting diodes and has a width of 4 cm in a direction longitudinally along an extension of the row.

7. The method of claim 1, wherein each of the other groups of the plurality of LED groups has at least two light emitting diodes which are activated simultaneously.

8. The method of claim 1, wherein each of the other groups of the plurality of LED groups has three light emitting diodes which are activated simultaneously.

9. The method of claim 1, further comprising supplying for a predetermined time period continuously increasing electric power to the other groups of the plurality of LED groups as the other groups of the plurality of LED groups are successively activated.

10. A turn signal lighting system for a motor vehicle, said lighting system comprising:
a plurality of light emitting diodes arranged in a row and interconnected to form a plurality of LED groups, each of the plurality of LED groups having at least one of the light emitting diodes; and
a control device configured
to activate a first group of the plurality of LED groups,
to activate subsequently the other groups of the plurality of LED groups successively until the plurality of LED groups are all in an ON state,
to maintain the plurality of LED groups in the ON state for a predetermined time period, and
to deactivate the plurality of LED groups,
wherein an overall time period from switching on the first group of the plurality of LED groups until reaching the ON state of the plurality of LED groups ranges from 100 ms to 200 ms.

11. The lighting system of claim 10, wherein the overall time period ranges from 140 ms to 160 ms.

12. The lighting system of claim 10, wherein the predetermined time period ranges from 50 ms to 400 ms.

13. The lighting system of claim 10, wherein the predetermined time period ranges from 200 ms to 300 ms.

14. The lighting system of claim 10, wherein the first group of the plurality of LED groups is located at an end of the row.

15. The lighting system of claim 10, wherein the first group of the plurality of LED groups includes at least eight light emitting diodes and has a width of 4 cm in a direction longitudinally along an extension of the row.

16. The lighting system of claim 10, wherein at least one of the groups of the plurality of LED groups has at least two light emitting diodes.

17. The lighting system of claim 10, wherein at least one of the groups of the plurality of LED groups has three light emitting diodes.

18. The lighting system of claim 10, wherein the control device is configured to supply for a predetermined time period continuously increasing electric power to the other groups of the plurality of LED groups as the other groups of the plurality of LED groups are successively activated.

19. The lighting system of claim 10, wherein the light emitting diodes of at least one group of the plurality of LED groups are arranged side-by-side in a direction longitudinally along an extension of the row.

20. The method of claim 1, wherein at least two groups of the plurality of LED groups have different lengths in a direction longitudinally along an extension of the row.
